(19) United States
(12) Patent Application Publication
(10) Pub. No.: US 2006/0061769 A1
(43) Pub. Date: Mar. 23, 2006

(54) Homodyne based optical coherence microscope

(75) Inventors: Changhuei Yang, Pasadena, CA (US); Xin Heng, Pasadena, CA (US); Zahid Yaqoob, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA (US)

(21) Appl. No.: 11/218,918

(22) Filed: Sep. 2, 2005

Related U.S. Application Data
(60) Provisional application No. 60/606,970, filed on Sep. 3, 2004.
(60) Provisional application No. 60/610,834, filed on Sep. 17, 2004.

(51) Int. Cl. G01B 9/02

(52) U.S. Cl. 356/479

(57) ABSTRACT

Optical coherence microscope (OCM) systems and methods that combine the capability of a confocal microscope to obtain high resolution images and the ability of low coherence interferometer (LCI) to obtain high-accuracy phase and amplitude information of samples. The OCM system of the present invention uses a homodyne approach and obtains complete quadrature results of amplitude and phase instantaneously without optical or electronic modulation as in conventional OCT systems. Because the OCM methods of the present invention use a homodyne approach for signal extraction, there is no minimum pixel dwell time associated with each pixel acquisition, and accurate interference phase and amplitude information is extracted.

### CROSS-REFERENCES TO RELATED APPLICATIONS

This application claims the benefit of U.S. Provisional Application 60/606,970, filed Sep. 3, 2004, and 60/610,834, filed Sep. 17, 2004, both titled “HOMODYNE BASED OPTICAL COHERENCE MICROSCOPE,” which are hereby incorporated by reference in their entirety.

### BACKGROUND OF THE INVENTION

The present invention relates generally to broadband interferometry systems and methods, and more particularly to optical coherence microscopy systems and methods for obtaining high resolution depth-resolved images of samples as well as high-accuracy phase and amplitude information of the interferometric signals.

Interferometry with broadband light sources has become a widely used technique for imaging in biologic and other samples using time-domain optical coherence tomography (OCT), optical coherence microscopy (OCM), spectral domain OCT (which encompasses spectrometer based Fourier domain OCT and swept source OCT), color Doppler OCT, and phase-referenced interferometry. In all of these interferometry techniques, light traveling a reference path is mixed with light returning from or traversing a sample on the surface of a single or multiple detectors.

For homodyne interferometry, the optical frequency of the sample and reference light is the same, and mixing of the fields on the detector results in sum and difference frequency terms corresponding to a second harmonic frequency component and a DC frequency component. The second harmonic frequency component is at twice the optical frequency, and is therefore not resolved by conventional square-law electronic detectors.

For heterodyne interferometry, either the reference or sample arm light is purposefully modulated at a carrier frequency, which results in the difference frequency component residing on a carrier frequency which is electronically detectable. The complete interferometric signal consists of DC components arising from non-mixing light from each of the arms, and interferometric components arising from mixed light. In heterodyne interferometry it is straightforward to separate the DC components from the interferometric components, since the latter are distinguished by their carrier frequency. In homodyne interferometry, it is not possible to separate the interferometric and non-interferometric components based on their frequency content alone.

In both homodyne and heterodyne interferometers, the interferometric component of the detector signal depends sinusoidally on both the optical path length difference between the arms of the interferometer, and also on an additional phase term which specifies the phase delay between the reference and sample arm fields when the path length difference is zero. When this phase term is zero, the interferometric signal varies as a cosine of the optical path length difference between the arms, and when the phase term is 90 degrees, the interferometric signal varies as a sine of the path length difference. Although a single detector can only detect one of these phase components at a time, it is convenient to refer to the zero and 90 degree phase delayed versions of the interferometric signal as the real and imaginary components (or zero and 90 degree quadrature components) of a complex interferometric signal.

In OCT systems, low coherence interferometry (LCI) is used to obtain depth-resolved reflectivity of a sample. Using broadband light sources in the near-infrared, penetration depths can reach a few millimeters for a sample including translucent and turbid materials (e.g., polymers). Heterodyne-based OCT systems generally acquire depth resolved scans (A-scans), since the general incorporation of a moving element to induce the necessary heterodyne beat generally generates a varying optical delay. This optical delay can be used to render depth resolved scans. Heterodyne-based systems can disentangle depth scans from the heterodyne beat generation process through the use of other optical elements, such as an acousto-optic modulator or electro-optic modulator. Such distanglement allows for easier en-face scan pattern (to create en-face images), by then scanning the focal point created by the OCT horizontally within the sample. However, such systems generally set a limit on the speed of en-face scanning; each pixel dwell time must be larger than the heterodyne frequency, which leads to slow scan speed due to low heterodyne beat frequency, or high scan speed with a high heterodyne beat frequency. The first situation is not ideal in terms of image acquisition speed. The second requires fast data collection and processing and entails sophisticated instrumentation.

In conventional optical coherence tomography (OCT), pixel information generation therefore requires the generation of a heterodyne interference signal, demodulation at the heterodyne frequency of the detected signal and subsequent pixel signal assignment. The use of a heterodyne carrier frequency necessarily imposes a minimum dwell time associated with each pixel acquisition. In addition, such implementation schemes require the use of fairly elaborate modulation and demodulation hardware and software.

Therefore it is desirable to provide systems and methods that overcome the above and other problems. In particular, it would be desirable to provide optical coherence microscope systems and methods that allow for instantaneous and simultaneous acquisition of amplitude and phase information, and which exhibit high image acquisition rates.

### BRIEF SUMMARY OF THE INVENTION

The present invention provides OCM systems and methods for imaging samples and obtaining amplitude and phase information of interferometric signals.

The present invention provides, in one embodiment, a novel optical coherence microscope (OCM) configuration that naturally, and simultaneously, combines the capability of a confocal microscope to obtain high resolution images and the ability of low coherence interferometer (LCI) to obtain high-accuracy phase and amplitude information of samples. An advantageous feature of OCM system of the present invention is that by the nature of 3×3 optical coupler, the system can obtain complete quadrature results of amplitude and phase instantaneously without optical or electronic modulation as in conventional OCT systems.

Because the OCM methods of the present invention use a homodyne approach for signal extraction, there is no minimum pixel dwell time associated with each pixel acquisition. The present invention is also much simplified in comparison with a heterodyne based scheme. Finally, the present invention enables a more accurate interference phase extraction.

The robust and compact configuration of multi-functional optical microscope of the present invention is extremely useful to biology research applications.

According to one aspect of the present invention, an optical coherence microscope system is provided. The system typically includes a light source that provides broadband illumination light, and an optical N×N coupler having a plurality, N, of input ports and a plurality, N, of output ports, wherein a first one of the input ports is optically coupled to receive the broadband illumination light. The system also typically includes a reference light path optically coupled to a first one of the output ports, wherein the reference light path includes a reflector element and has an adjustable path length, and a sample light path optically coupled to a second one of said output ports, the sample light path including a lens and a pinhole configured in a confocal microscope arrangement. The system further typically includes a detector system optically coupled to each of said plurality of input ports. In operation, the broadband illumination light received at the first input port is directed to the plurality of output ports, wherein the broadband illumination light illuminates a sample in the sample path, wherein light scattered by the sample is received by the second output port and directed to the plurality of input ports, wherein the detector system detects light scattered by the sample, wherein light reflected by the reflector element is received by the first output port and directed to the plurality of input ports, and wherein the detector system detects reference light reflected from the reflector element. In certain aspects, N is 3.

According to another aspect of the present invention, a method is provided for imaging a sample. The method typically includes illuminating a sample with broadband illumination light using a confocal microscope arrangement in a first optical path optically coupled to a first output port of a 3×3 fiber coupler, and detecting light scattered from the sample using a detector system optically coupled to each of 3 input ports of the 3×3 optical coupler. The method also typically includes directing reference light comprising the broadband illumination light along a reference optical path having an adjustable length, the reference optical path being coupled to a second output port of the 3×3 coupler, detecting broadband illumination light reflected in the reference arm light with the detector system, and processing interferometric signals derived from the detected reflected reference light and the light scattered from the sample to determine phase and amplitude information.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a microscope configuration according to one embodiment of the present invention.

FIG. 2 illustrates a microscope configuration according to another embodiment of the present invention.

FIG. 3 shows an example of a coefficient table for a 3×3 coupler, according to the present invention.

### DETAILED DESCRIPTION OF THE INVENTION

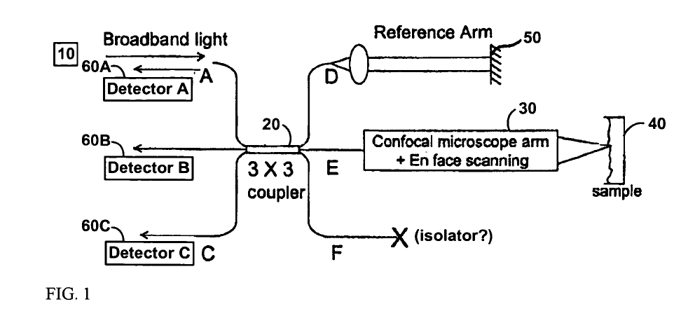

One embodiment of a microscope according to the present invention is shown in FIG. 1. A broadband light source 10 provides broadband light (input source light) that is coupled into a 3×3 fiber coupler 20 at port A. The exiting light at port E is channeled through a microscopic objective lens 30 and focused at an appropriate image plane on or within the target sample 40. Light that is backscattered by sample 40 is collected and recoupled through the fiber coupler 30. Using scanners, the focal spot of the input light can be quickly moved across the image plane to allow for a rapid acquisition of the backscattered light signal from the entire image plane. For convenience, this recoupled light will be referred to as the signal arm light. The input source light exiting at port D is reflected off a mirror 50 and recoupled into the fiber coupler 20 as well. This light component will be referred to as the reference arm light. The position of the reference arm mirror 50 is adjustable and allows for adjusting the coherence gating of the signal arm light component. In general, for an OCM imaging system the position of the reference arm is adjusted so that the coherence gate coincides with the image plane of the microscope system.

The recoupled light components mix in the coupler 20 and exit through ports A, B and C. The output signals at ports A, B and C are detected by three detectors 60, and the signals are converted and streamed into a processor or computer system, e.g., via an analog-to-digital converter, for processing and analysis of the interferometric signals. In one aspect, extraction of the light component of port A is facilitated by the use of an optical circulator (not shown) so as to ensure that the input source light is minimally impacted.

By power conservation argument, the output light components at port A, B and C will have different but determinable phase relationships relative to the phases of the signal arm and reference arm light sources. For example, in the case where the splitting ratio of the fiber coupler 20 is equal for all arms, the phase difference between A and B will be 120°, and 240° between A and C.

The resulting detected interference signals from the 3 ports are then processed to extract the signal amplitude and phase shift associated with the backscattered light component from a specific depth within the sample. Details of useful signal processing techniques can be found in published U.S. patent application 2004/0239943 A1, titled “System and Method for Low Coherence Broadband Quadrature Interferometry”, which is hereby incorporated by reference in its entirety for all purposes.

In certain aspects, the reference arm mirror 50 is adjustable using a modulator element such as one or more motorized micrometers (e.g., for translations up to 25 mm or longer) and/or piezoelectric actuators (e.g., for translations up to 100 microns).

The present invention is discussed with reference to embodiments including a 3×3 fiber optic coupler. However, it should be appreciated that embodiments of the present invention include a N×N coupler where N>2.

According to one embodiment of the present invention, a confocal microscope counterpart employing a high NA objective lens (and pinhole) is used in the sample arm. In this embodiment, sample arm 30 includes an objective lens and pinhole configured in a confocal microscope arrangement. In this manner, the coherence gating ability of low coherence interferometry is advantageously combined with the confocal gating ability of confocal microscopy. High resolution in all three dimensions is obtainable.

The microscope configuration as shown in FIG. 1 is not suited for exact phase measurements as any movement of the reference arm will introduce a phase shift error on the homodyne phase measurement process. To compensate for this, a second light source, which has a monochromatic output and different wavelength relative to source 10, is channeled into the same interferometer. A dichroic mirror is used to detect the interference output of the monochromatic source separately. The measured phase signal associated with the second (monochromatic) source is used as a reference ruler to track the undesirable movements of the reference mirror 50. Through such a compensation scheme, the phase shift measured for the low coherence light source 10 can advantageously be related to the physical properties of the target sample.

List of Microscope Features:

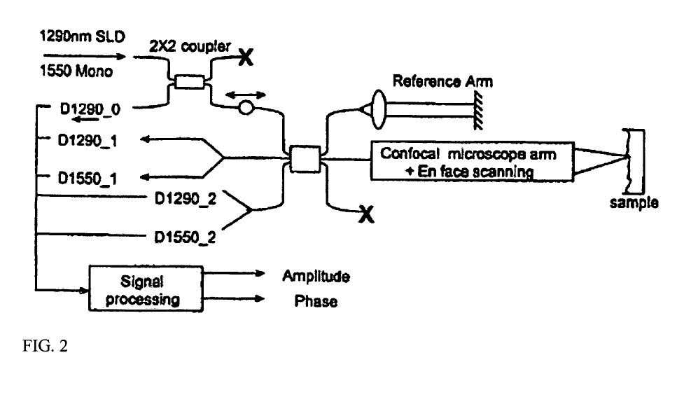

Some characteristic features of the microscope depicted in FIG. 2 and example of applications are listed below:

(1) Instantaneous quadrature information of both amplitude and phase of biological targets.

For the nature of the 3×3 optical coupler, outputs from individual ports have non-trivial phase shift, where the opposite refers to π phase difference embedded in 2×2 optical couplers that are conventionally used in OCT.

The interferometric signals coming from the 3 coupler arms are:
i₀=2α₄₁α₄₁α₅₁α₅₁\sqrt{RᵣRₛ(z)h(z)}I(z)cos(2k₀z) (1a)
i₁=2α₄₂α₄₁α₅₂α₅₁\sqrt{RᵣRₛ(z)h(z)}I(z)cos(2k₀z+φ₁) (1b)
i₂=2α₄₃α₄₁α₅₃α₅₁\sqrt{RᵣRₛ(z)h(z)}I(z)cos(2k₀z+φ₂) (1c)

It should be understood that:
1) iₙ contains interferometric terms only. Non-interferometric terms can be separated out.
2) aᵢⱼ is coupler's coefficient (j to i), which are experimentally determined.
3) Rᵢ(z),h(z) are the reflectance of sample and intensity distribution of light passing through objective lens, respectively z is the displacement from the path-length matching position.
4) I(z) is the correlation function of broadband SLD light source.
5) φ₁, φ₂ are natural phase shifts between different ports of the 3×3 optical coupler, which are experimentally determined. For lossless equal—splitting coupler, phase difference is 2π/3.

Any two equations from equation set 1 will be sufficient to create a sinusoidal interferometric term, i.e.,
_{0,1m}=2α₄₁α₄₁α₅₁α₅₁\sqrt{RᵣRₛ(z)h(z)}I(z)sin(2k₀z) (2)

Then the full quadrature information will be readily obtained as:

$$\begin{matrix}{I}_{0} = \sqrt{{i}_{0}^{2} + {i}_{0 , lm}^{2}} & ( 3 a ) \\ 2 {k}_{0} z ( t ) = arctan ( \frac{{i}_{0}}{{i}_{0 , lm}} ) & ( 3 b )\end{matrix}$$

It should also be understood that:

(1) z(t) has a period of π. However, with a fast data acquisition system, real-time mapping of z(t) over a large spatial range beyond optical wavelength is possible; plus, in cell dynamics applications, cell membranes typically only vibrates at the sub-micron level, thus having no π phase-ambiguity problem.

(2) as mentioned, two equations from equation set 1 generally suffices for the generation of full quadrature information, but all three equations are needed in order to separate out the non-interferometric terms (not shown in equation 1).

(2) Homodyne detection, free from phase modulation

One advantage of using 3×3 couplers is that three independent equations (see Equation 1) are obtained, combining amplitude and phase information to be extracted. There are essentially three variables to solve (amplitude of the interferometric term, the cosine of the phase and the sine of the phase). In conventional OCT, there are only two independent equations.

The systems and methods of the present invention remove the necessity of phase modulation of conventional OCT, thereby removing numerous physical constraints of phase modulators (e.g., nonlinear oscillatory motion, ultimate speed of phase modulations). As a result, the present invention provides a homodyne detection scheme that differs greatly from other existing time-domain OCT systems.

Additionally, by using the OCM system of the present invention, phase information (i.e., 2k₀z(t)) can be obtained substantially instantaneously. Therefore, when phase information is needed in the situation such as Doppler OCT, time-consuming digital signal manipulations like Digital Hilbert Transforms, or additional complex setups as in phase-stepping OCT are advantageously not necessary when using the present invention.

(3) High resolution en face images.

The well-known depth resolving capability of OCT is embedded in the broad bandwidth light source and the interferometric nature of the system. Physically, only the reflectors (e.g., on or in the target sample) whose total optical path length match up with that of reference mirror within the range of the light source's coherence length contribute dominantly to the final OCT image. On the other hand, the resolving ability of a confocal microscope is realized by spatial filters (pinholes) and high-NA objective lenses in the sense that the light out-of-focus is rejected and does not affect the images.

As mentioned above, in certain embodiments of the present invention, a confocal microscope counterpart employing a high NA objective lens is used in the sample arm. In this manner, the coherence gating ability of low coherence interferometry is advantageously combined with the confocal gating ability of confocal microscopy. High resolution in all three dimensions is obtainable.

Different from OCT that acquires X-Z cross section images of biological samples, the OCM techniques of the present invention advantageously acquires en face images whose frame rate and size are determined by the capabilities of the laser scanner used. One example of a useful laser scanner is two orthogonally mounted computer controlled “galvanometer” or galvo mirror based beam steering devices. This configuration allows fast beam scanning in two-dimensional (2-D) space for en-face images. Another example of 2-D laser scanner is a movable mirror mounted on PZT (lead zirconate titanate) based piezoelectric linear actuators driven differentially in orthogonal pairs. Other scanning elements and configurations would be apparent to one skilled in the art.

Examples of useful applications of the present invention include surface imaging of biological samples and other samples, and Doppler imaging of microvascular networks in X-Y plane. One non-negligible advantage of using en face OCM over OCT is that this OCM system maintains a more or less constant image contrast in one single X-Y plane. However, in OCT the signal-to-noise ratio (SNR) gets much degraded when going deeper and deeper into the sample during a tomographic framing (X-Z), especially in a turbid medium (e.g., a polymer), for the reason that a large amount of photons are scattered or reflected before reaching the image plane that will be reflected in one tomographic image.

(4) High resolution in a turbid medium

Another problem of confocal microscopes is that the imaging quality becomes much more degraded when it is applied to thick samples or samples included in, or comprising, a turbid medium. There is much unavoidable scattered light mixing with the in-focus light that no good way exists to differentiate light containing real information from interruptive light from other locations.

However, in the OCM system of the present invention, the dominant contributions to imaging come from those photons that travel the same optical distance as those traveling in the reference arm. Scattered photons appearing from other depths or locations are automatically ‘filtered out’ by the physical nature of LCI with an accuracy the same as the coherence length. In certain aspects, an achievable signal to noise ratio of the present invention is about 90 dB or greater.

Thus, the present invention advantageously extends the imaging capability of confocal microscopes into the situations of high scattering media and thick samples, while the high resolution features of the imaging system are still well maintained.

(5) Measure the coupling coefficients of 3×3 optical coupler.

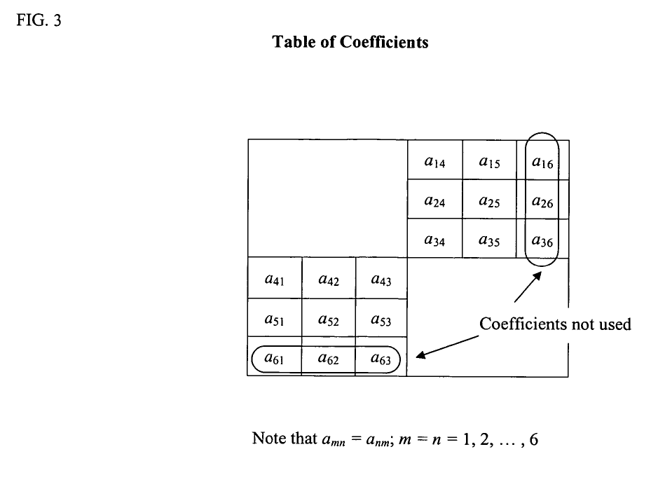

In one aspect, a systematic way of measuring the coupling coefficients of the N×N, e.g., 3×3, coupler is provided. A coefficient table is generated. For example, it can be seen from Eqs. 1 (a)-(c) that the determination of interferometric signals at the three photodetectors requires the knowledge of 3×3 optical coupler's coefficients. Further, Eqs. (1a) and (2) are simultaneously solved to determine amplitude and phase information given by Eqs. 3(a) and (b), respectively. An example of a coefficient table for a 3×3 coupler is shown in FIG. 3. This coefficient table is very useful in characterizing the quality of multi-arm optical fiber couplers. The coefficient table is also extremely useful for data processing and homodyne detection.

(6) Applications of the interferometric techniques of the present invention include:

a) Multifunctional imaging system in a compact volume (e.g., the OCM systems and methods of the present invention can be readily combined with other imaging modes, such as Spectral domain optical coherence tomography, multi-photon microscopy, and near-field optical imaging systems, e.g., photon tunneling microscopes and near-field scanning microscopes). One ultimate goal is to develop a user-friendly turnkey-type optical imaging device.

b) Image cell dynamics at the level of 10's-100's nm resolution. For example, a time trace of cell membrane motions with the changes of medium, environment can be obtained.

c) Micro-fluid flows of micron-sized channels; Micro-fluidic optical sensor.

d) Imaging and flow information of various microvascular networks.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical coherence microscope system, comprising:
a light source that provides broadband illumination light;
an optical N×N coupler having a plurality, N, of input ports and a plurality, N, of output ports, wherein a first one of the input ports is optically coupled to receive the broadband illumination light;
a reference light path optically coupled to a first one of the output ports, wherein the reference light path includes a reflector element and has an adjustable path length;
a sample light path optically coupled to a second one of said output ports, the sample light path including a lens and a pinhole configured in a confocal microscope arrangement;
a detector system optically coupled to each of said plurality of input ports,
wherein the broadband illumination light received at the first input port is directed to the plurality of output ports, wherein the broadband illumination light illuminates a sample in the sample path, wherein light scattered by the sample is received by the second output port and directed to the plurality of input ports, wherein the detector system detects light scattered by the sample, wherein light reflected by the reflector element is received by the first output port and directed to the plurality of input ports, and wherein the detector system detects reference light reflected from the reflector element.

2. The system of claim 1, wherein N>2.

3. The system of claim 1, wherein N=3.

4. The system of claim 1, wherein the light source includes a super luminescent diode (SLD).

5. The system of claim 1, wherein the sample light path and the reference light path each include a fiber optic cable.

6. The system of claim 1, wherein the detector system is coupled with a processor via one or more analog-to-digital converters.

7. The system of claim 1, wherein the reference light path includes an actuator element coupled to the reflector element, for adjusting the path length.

8. The system of claim 7, wherein the actuator includes a modulator element selected from the group consisting of motorized micrometers and piezoelectric actuators.

9. The system of claim 1, further comprising a source of monochromatic light optically coupled to the first input port.

10. The system of claim 9, comprising a 2×2 optical coupler optically coupling the monochromatic illumination source and the broadband light source with the first input port of the N×N coupler.

11. The system of claim 10, wherein a first input port of the 2×2 optical coupler is optically coupled to both the broadband and monochromatic illumination sources, and wherein a first output port of the 2×2 optical coupler is optically coupled to the first input port of the N×N coupler.

12. The system of claim 11, wherein the detector system is optically coupled to a second input port of the 2×2 coupler.

13. The system of claim 1, wherein the sample light path further includes a scanning element for scanning the illumination light in a two dimensional pattern across the sample.

14. The system of claim 13, wherein the scanning element includes one of a mirror mounted on PZT based piezoelectric linear actuators driven differentially in orthogonal pairs, or two orthogonally mounted galvo mirrors for beam steering in two-dimensional space for en-face images.

15. A method of imaging a sample, comprising:
illuminating a sample with broadband illumination light using a confocal microscope arrangement in a first optical path optically coupled to a first output port of a 3×3 fiber coupler;
detecting light scattered from the sample using a detector system optically coupled to each of 3 input ports of the 3×3 optical coupler;
directing reference light comprising the broadband illumination light along a reference optical path having an adjustable length, the reference optical path being coupled to a second output port of the 3×3 coupler;
detecting broadband illumination light reflected in the reference arm light with the detector system; and
processing interferometric signals derived from the detected reflected reference light and the light scattered from the sample to determine phase and amplitude information.

16. The method of claim 15, wherein N>2.

17. The method of claim 15, wherein the broadband illumination light is provided by a super luminescent diode optically coupled to a first input port of the 3×3 coupler.

18. The method of claim 15, wherein illuminating the sample includes scanning the broadband illumination light in a two dimensional pattern across the sample.

19. The method of claim 15, further including controllably adjusting the length of the reference optical path.

20. The method of claim 15, further including optically coupling a source of the broadband illumination light and a source of monochromatic light with a first input port of the 3×3 coupler using a 2×2 coupler.
